(19) United States
(12) Patent Application Publication
(10) Pub. No.: US 2006/0001628 A1
(43) Pub. Date: Jan. 5, 2006

(54) Flat display panel driving method and flat display device

(76) Inventor: Seiji Kawaguchi, Hirakata-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/172,835

(22) Filed: Jul. 5, 2005

(30) Foreign Application Priority Data
Jul. 5, 2004 (JP) 2004-197752

(51) Int. Cl. G09G 3/36

(52) U.S. Cl. 345/89

(57) ABSTRACT

A flat display device comprises a flat display panel which includes a matrix array of pixels, a plurality of scanning lines for selecting rows of pixels and a plurality of signal lines for supplying signals to a selected row of pixels, and a driver circuit which writes a video signal and a non-video signal into different rows of pixels during first and second periods provided for each horizontal scan period, respectively. The flat display device further comprises a controller which performs control of the driver circuit for precharging the signal lines during the first period to assist writing of the non-video signal assigned to the second period, as a blanking period process after writing of the video signal has been completed with respect to all the rows of pixels.

### CROSS-REFERENCE TO RELATED APPLICATIONS

This application is based upon and claims the benefit of priority from prior Japanese Patent Application No. 2004-197752, filed Jul. 5, 2004, the entire contents of which are incorporated herein by reference.

### BACKGROUND OF THE INVENTION

1. Field of the Invention

The present invention relates to a flat display device and a flat display panel driving method, and more particularly, to a flat display device such as an OCB-type liquid crystal display panel capable of providing a wide viewing angle and high-speed response, and a method of driving the flat display panel.

2. Description of the Related Art

Currently, liquid crystal display panels having characteristics such as lightness, thinness, and low power consumption are used as displays for television sets, personal computers and car navigation systems.

A twisted nematic (TN) type liquid crystal display panel widely utilized as this liquid crystal display panel is configured such that a liquid crystal material having optically positive refractive anisotropy is set to a twisted alignment of substantially 90° between glass substrates opposed to each other, and optical rotary power of incident light is adjusted by controlling its twisted alignment. Although this TN-type liquid crystal display panel can be comparatively easily manufactured, its viewing angle is narrow, and its response speed is low. Thus, this panel has been unsuitable to display a moving image such as a television image, in particular.

On the other hand, an optically compensated birefringence (OCB) type liquid crystal display panel attracts attention as a liquid crystal display panel which improves a viewing angle and a response speed. The OCB-type liquid crystal display panel is sealed with a liquid crystal material capable of providing a bend alignment between the opposed glass substrates. The response speed is improved by one digit as compared with the TN-type liquid crystal display panel. Further, there is an advantage that the viewing angle is wide because optically self compensation is made from an alignment state of the liquid crystal material.

In the OCB-type liquid crystal display panel, as shown in (a) of FIG. 5, liquid crystal molecules 65 of a liquid crystal layer are set to a splay alignment when no voltage is applied between a pixel electrode 62 disposed on a glass based array substrate 61 and an counter electrode 64 disposed similarly on a glass based counter substrate 63 which is opposed to the array substrate 61. Thus, when a high voltage of the order of some tens of voltages is applied between the pixel electrode 62 and the counter electrode 64 upon supply of power, the liquid crystal molecules 65 are transferred to the bend alignment.

To reliably transfer the alignment state upon high voltage application, voltages opposite in polarity are applied to adjacent horizontal lines of the pixels to create a nucleus by a laterally twisted potential difference between the adjacent pixel electrode 62 and transfer pixel electrode. The alignment state is transferred around the nucleus. Such an operation is carried out for substantially one second, whereby the splay alignment is transferred to the bend alignment. Further, a potential difference between the pixel electrode 62 and the counter electrode 64 is equalized, thereby temporarily eliminating an undesired record.

After the liquid crystal molecules 65 have been thus transferred to the bend alignment, a voltage exceeding a low OFF voltage, at which the liquid crystal molecules 65 are maintained in the bend alignment as shown in (b) of FIG. 5, is applied from a drive power supply 66 during operation. The OFF voltage or an ON voltage which is higher than the OFF voltage is applicable from the drive power supply 66 as shown in (c) of FIG. 5. Thus, the drive voltage between the electrodes 62 and 64 changes in the range of the OFF voltage to the ON voltage. Consequently, the alignment state of the liquid crystal molecules 65 is transferred between the bend alignment shown in (b) of FIG. 5 and the bend alignment shown in (c) of FIG. 5 to change a retardation value of the liquid crystal layer, thereby controlling transmittance.

In the case where an OCB-type liquid crystal display panel is used for displaying an image, birefringence is controlled in association with polarizing plates. The liquid crystal panel is driven by a driver circuit such that light is shielded (for a black display) upon application of a high voltage and is transmitted (for a white display) upon application of a low voltage, for example.

The driver circuit includes a scanning line driver circuit 67 which is formed integrally on the array substrate 61 as shown in FIG. 6 and from which a plurality of scanning lines (gate lines) Y1 to Yn extend in a row direction, and a signal line driver circuit (not shown) from which a plurality of signal lines (source lines) X1 to Xm extend in a column direction to intersect the scanning lines Y1 to Yn.

The signal lines X1 to Xm are divided into odd numbered signal lines X1, X3, . . . and even numbered signal lines X2, X4, . . . , and drain-source paths of thin film transistors (TFTs) 68-1, 68-2, . . . 68-m′ (m′=2m) configured as a pair of selector switches on an even number and odd number basis are connected to the respective signal lines X1 to Xm in parallel with each other. Among them, gates of TFTs 68-1, 68-3, . . . of an odd numbered set is connected to a terminal 69 to which a first selection signal is supplied, and gates of TFTs 68-2, 68-4, . . . of an even numbered set is connected to a terminal 70 to which a second selection signal is supplied, so that a video signal supplied to each of terminals 71, 72 is selected by the corresponding selection signal.

Switching thin film transistors (TFTs) 73 are disposed at intersections between the scanning lines Y and the signal lines X in which the drain-source paths of the TFTs 68-1 to 68-m′ are inserted. Each TFT 73 has a gate connected to one of the scanning lines Y1 to Yn, and a drain-source path connected at one end to one of the signal lines X. The other end of the drain-source path of the TFT 73 is connected to a liquid crystal capacitance element 74, and is connected to one end of a storage capacitance element 75. The other end of the storage capacitance element 75 is connected to a terminal 76 via a capacitance line Cs, and a storage capacitance voltage is applied from the terminal 76.

In addition, a vertical scanning clock signal and a vertical start signal are supplied to the scanning line driver circuit 67 via a terminal 77 and a terminal 78, respectively.

With such a configuration, a gate pulse from the scanning line driver circuit 67 is sequentially supplied to the scanning lines Y1 to Yn by line at a time driving method, and TFTs 73 on one scanning line X are turned on simultaneously. In synchronism with this scanning, video signals from the signal line driver circuit are supplied via the terminals 71, 72 and the TFTs 68-1 to 68-m′ to the TFTs 73, to store a signal charge in each liquid crystal capacitance element 74 and the corresponding storage capacitance element 75 through the drain-source path of the corresponding TFT 73. The signal charge is held until a next scanning period has been established. Consequently, the liquid crystal capacitance elements 74 of all pixels connected to the scanning lines X are activated to display an image, the storage capacitance elements 75 are driven by a storage capacitance voltage which is applied by grounding the terminal 76 or by supplying a gate pulse in a reverse phase and supplied to the terminal 76.

In such a liquid crystal display panel, for example, in a first half of one horizontal scanning period (1H), a signal voltage having positive polarity (+) with respect to a voltage of the counter electrode 64 is written into the pixel electrode 62 connected via the TFT 68-1 for the signal line X1, and a signal voltage having negative polarity (−) with respect to a voltage of the counter electrode 64 is written into the pixel electrode 62 connected to the TFT 68-4 for the signal line X2, respectively, as shown in (a) of FIG. 7.

In a latter half of 1H, a signal voltage having negative polarity (−) with respect to a voltage of the counter electrode 64 is written into the pixel electrode 62 connected via the TFT 68-2 for the signal line X2, a signal voltage having positive polarity (+) with respect to a voltage of the counter electrode 64 is written into the pixel electrode 62 connected via the TFT 68-3 for the signal line X.

In addition, in a next frame, in a first half of 1H, a signal voltage having negative polarity (−) with respect to a voltage of the counter electrode 64 is written into the pixel electrode 62 connected to via the TFT 68-1 for the signal line X1, and a signal voltage having positive polarity (+) with respect to a voltage of the counter electrode 64 is written into the pixel electrode 62 connected via the TFT 68-4 for the signal line X2, respectively, as shown in (b) of FIG. 7.

In a latter half of 1H, a signal voltage having positive polarity (+) with respect to a voltage of the counter electrode 64 is written into the pixel electrode 62 connected via the TFT 68-2 for the signal line X2, and a signal voltage having negative polarity (−) with respect to a voltage of the counter electrode 64 is written into the pixel electrode 62 connected via the TFT 68-3 for the signal line X1. In this manner, frame inversion driving and dot inversion driving are carried out, thereby preventing an application of an undesired direct current voltage and preventing an occurrence of flickering.

In such an OCB-type liquid crystal display panel, the alignment state can be transferred from the spray alignment to the bend alignment by means of a voltage applied between the pixel electrode 62 and the counter electrode 64. However, even if the bend alignment has been established, so-called inverse transfer from the bend alignment to the splay alignment easily occurs if the voltage held between the pixel electrode 62 and the counter electrode 64 is maintained at low voltage level. This raises a problem that a display image cannot be recognized.

As a countermeasure against the problem caused by the inverse transfer, it is necessary that a high voltage is periodically applied (black-signal inserted) to a liquid crystal layer to prevent occurrence of the inverse transfer phenomenon. Insertion of the black signal is executed not only during a video image display period but also during a blanking period so as to prevent an occurrence of the inverse transfer phenomenon. However, there is no denying on insufficient charging of signal lines (source lines) in the blanking period. If insufficient charging occurs, ghosting occurs on a display screen, and in particular, the ghosting (blanking band) in a gray filled-in state is likely to be outstanding as compared with another display state. Therefore, there is a problem that the ghost image causes very serious degradation of a screen display resolution or an inverse transfer phenomenon in a white filled-in state occurs.

### BRIEF SUMMARY OF THE INVENTION

The present invention has been made in order to solve the foregoing problems. It is an object of the present invention to provide a flat display panel driving method and a flat display device in which ghosting or an inverse transfer phenomenon due to insufficient charging of signal lines is reliably prevented.

According to a first aspect of the present invention, there is provided a flat display panel driving method for driving a flat display panel which includes a matrix array of pixels, a plurality of scanning lines for selecting rows of pixels, and a plurality of signal lines for supplying signals to a selected row of pixels, the method comprising: writing a video signal and a non-video signal into different rows of pixels during first and second periods provided for each horizontal scan period, respectively; and precharging the signal lines during the first period to assist writing of the non-video signal assigned to the second period, as a blanking period process after writing of the video signal has been completed with respect to all the rows of pixels.

According to a second aspect of the present invention, there is provided a flat display device comprising: a flat display panel which includes a matrix array of pixels, a plurality of scanning lines for selecting rows of pixels, and a plurality of signal lines for supplying signals to a selected row of pixels; a driver circuit which writes a video signal and a non-video signal into different rows of pixels during first and second periods provided for each horizontal scan period, respectively; and a controller which performs control of the driver circuit for precharging the signal lines during the first period to assist writing of the non-video signal assigned to the second period, as a blanking period process after writing of the video signal has been completed with respect to all the rows of pixels.

With the flat display panel driving method and flat display device, the signal lines are precharged during the first period to assist writing of the non-video signal assigned to the second period, as a blanking period process after writing of the video signal has been completed with respect to all the rows of pixels. Such precharging counters insufficient charging of the signal lines. Thus, the occurrence of ghosting, including ghosting (blanking band) in a gray filled-in state or an inverse transfer phenomenon in a white filled-in state, is reliably prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the circuit configuration of a flat display device according to one embodiment of the present invention;

FIG. 2 is a signal waveform chart for explaining an operation of the flat display device shown in FIG. 1;

FIG. 3 is a diagram showing a modification of the circuit configuration of the flat display device shown in FIG. 1;

FIG. 4 is a signal waveform chart for explaining an operation of the modification shown in FIG. 3;

FIG. 5 is a diagram for explaining a display principle of a conventional OCB-type liquid crystal display panel;

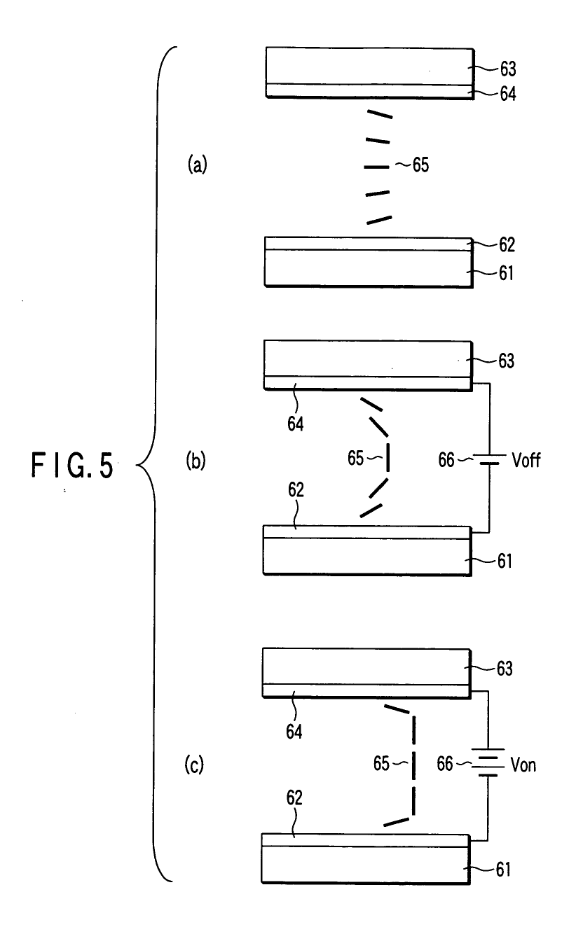

FIG. 6 is a diagram showing the circuit configuration of the liquid crystal display panel shown in FIG. 5; and

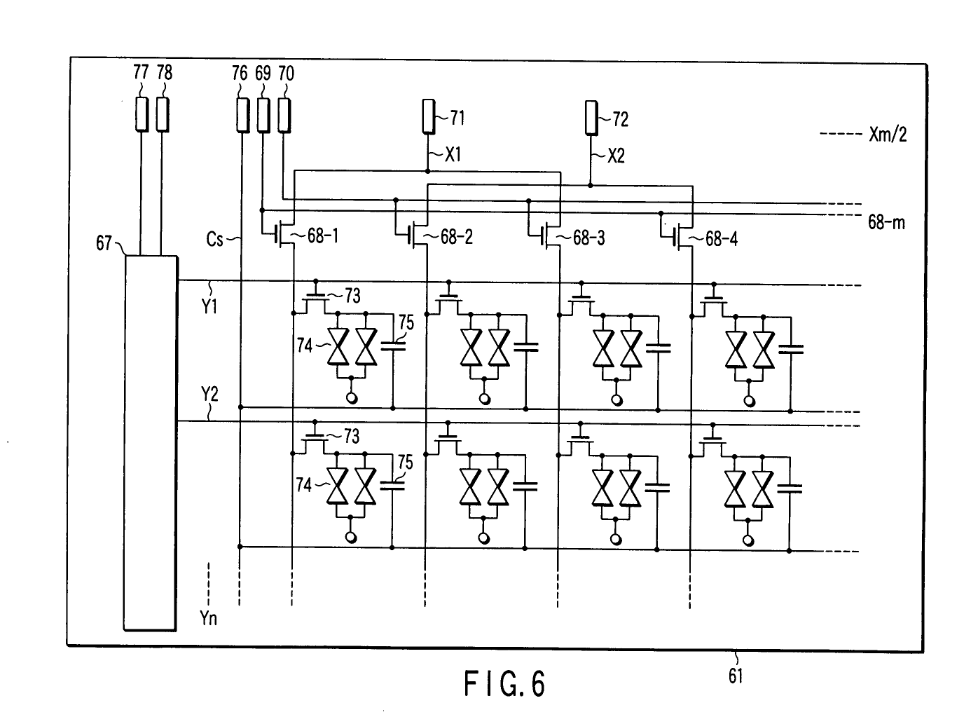

FIG. 7 is a diagram for explaining a method of driving the liquid crystal display panel shown in FIG. 6.

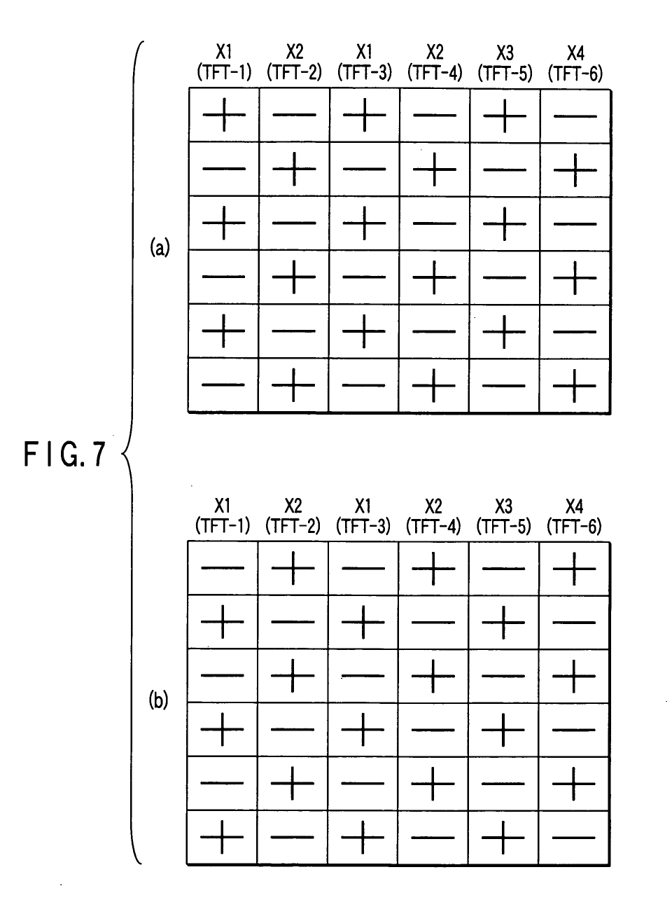

### DETAILED DESCRIPTION OF THE INVENTION

A flat display device according to one embodiment of the present invention will be described in detail with reference to the accompanying drawings.

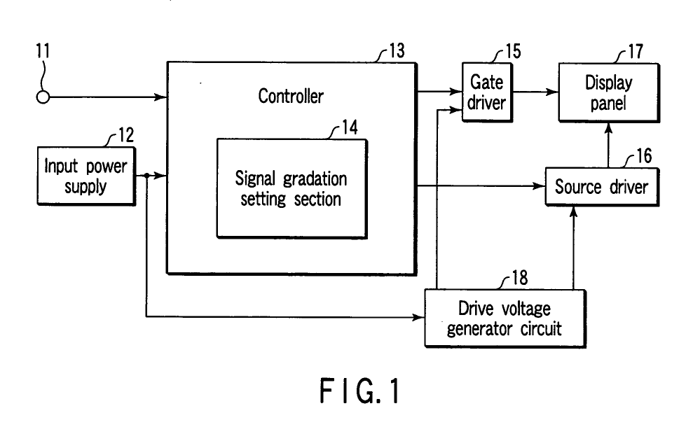

As shown in FIG. 1, input signals such as a vertical sync signal, a horizontal sync signal and a video signal are input from an input terminal 11 in the flat display device. These input signals are supplied to a controller 13 energized by an input power supply 12. The controller 13 incorporates a signal gradation setting section 14 which operates in a blanking period. The signal gradation setting section 14 is designed to set a source line charge waveform at an intermediate gradation in a video-signal omission part of the blanking period, the gradation being determined based on a temperature or display image. The controller 13 supplies drive signals to a gate driver 15 and a source driver 16, respectively. A gate pulse, a video signal, a black signal, and other signals are supplied from the gate driver 15 and the source driver 16 to a flat display panel 17 such as an OCB-type liquid crystal display panel. Drive voltages are also supplied to the gate driver 15 and the source driver 16 from a drive voltage generator circuit 18 which is connected to the input power supply 12. The gate driver 15 and the source driver 16 are configured to display an image on the flat display panel 17 using the drives voltage and gate pulse as well as the video signal, etc.

In the OCB mode, continuous application of a low voltage allows the alignment state of liquid crystal molecules to be inverse-transferred from the bend alignment to the splay alignment. The black signal is a signal for preventing the inverse transfer phenomenon, and used as an example of the non-video signal in this embodiment. A write operation for the black signal is called black insertion, and the black signal is inserted at a desired black insertion rate for each field. The black insertion ratio is controlled as a time difference between the write timing for writing the video signal into a row (line) of the pixels and the write timing for writing the black signal into these pixels.

In a video display period, writing of a video signal and writing of a black signal are alternately carried out during first and second periods provided for each horizontal scan period. In a blanking period, writing of the black signal is carried out during the second period as well. By the signal gradation setting section 14 in the controller 13, the charge waveform in the blanking period is set at an intermediate gradation, which is determined based on a temperature or display image, thereby attempting to eliminate insufficient charging in the blanking period.

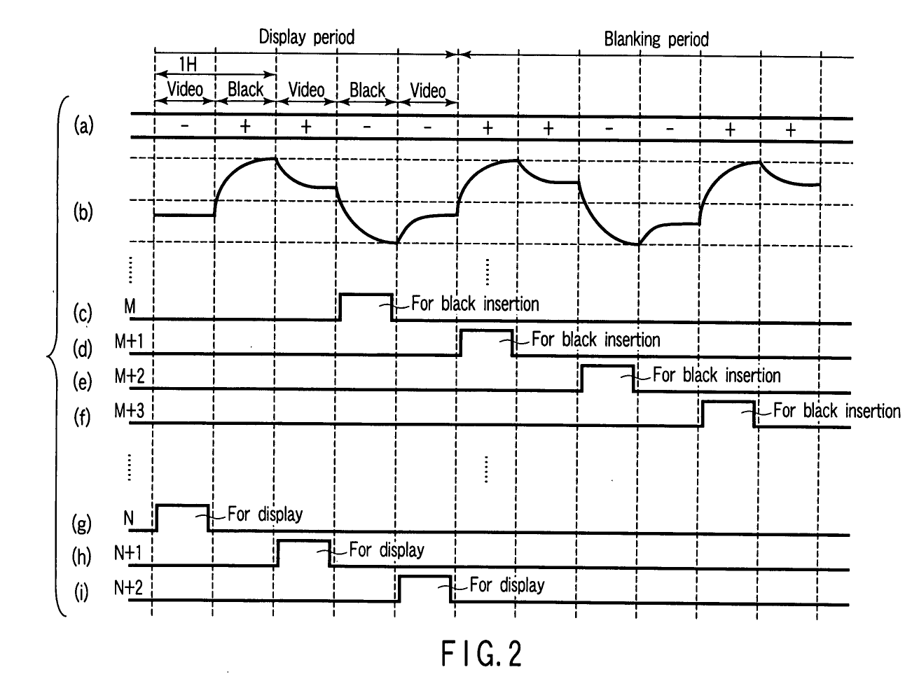

That is, as shown in FIG. 2, a video signal and a black signal are alternately written during a 1H period of the video display period, and the blanking period serves as a black display period. As shown in (a) of FIG. 2, the video signal and the black signal are supplied to the source driver 16 as signals whose polarities are inverted every 1H. The source line charge waveform is determined by each of the signals supplied to the source driver 16 such that the source line is charged or discharged according to the signal polarity, as shown in (b) of FIG. 2. At this time, the gate driver 15 operates to supply a gate signal. A black insertion gate pulse is supplied, for example, to an M-th gate line at a time slot for the black signal in the video display period, as shown in (c) of FIG. 2. A black insertion gate pulse is supplied similarly to an M+1-th gate line, at a time slot for the black signal in the blanking period, as shown in (d) of FIG. 2. Further, black insertion gate pulses are supplied to an M+2-th gate line and an M+3-th gate line similarly, as shown in (e) of FIG. 2 and (f) of FIG. 2, respectively.

On the other hand, a video signal writing gate pulse is supplied to an N-th gate line, as shown in (g) of FIG. 2. Video signal writing gate pulses are supplied to an N+1-th gate line and an N+2-th gate line at time slots for the video signal in the video display period, as shown in (h) of FIG. 2 and (i) of FIG. 2, respectively.

For the blanking period, the signal gradation setting section 14 incorporated in the controller 13 determines a signal gradation such that the source line charge waveform is set at an intermediate gradation in a video-signal omission part of the blanking period, in other words, in a part of the blanking period other than that for supply of the black insertion gate pulse. In this manner, sufficient charging of the source lines is attainable even if the gate pulse is generated only at the original insertion time slot for the black signal. Thus, the problem caused by insufficient charging of the source lines is eliminated.

Waveform setting in the blanking period by the signal gradation setting section 14 serves as a countermeasure against insufficient charging, and causes an increase in the charge voltage to reduce a difference between the luminance obtained by the source line charge waveform in the video-signal omission part of the blanking period and that obtained by the source line charge waveform in the video-signal part of the video display period.

Insufficient charging of the source lines in the blanking period occurs in the case where a gate pulse is generated at the original insertion time slot for black signal in the blanking period, as in the video display period. However, an intermediate gradation signal is set in the video-signal omission part of the blanking period to obtain substantially equivalent luminance in comparison with the video-signal part of the video display period, thereby preventing a difference in luminance from occurring between the video display period and the blanking period. Accordingly, insufficient charging that occurs upon transition of polarity due to an increase in the liquid crystal capacitance at a low temperature is eliminated. This prevents an occurrence of ghosting or an occurrence of an inverse transfer phenomenon in a white filled-in state.

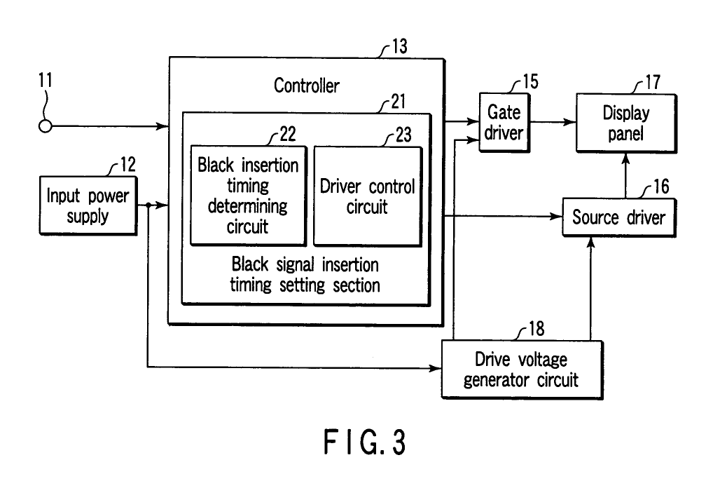

A description will now be given with respect to a modification of the circuit configuration of the flat display device shown in FIG. 1. As shown in FIG. 3, input signals such as a vertical sync signal, a horizontal sync signal and a video signal are input from an input terminal 11. These input signals are supplied to a controller 13 energized by an input power supply 12. The controller 13 incorporates a black signal insertion timing setting section 21. The black signal insertion timing setting section 21 is composed of a black insertion timing determining circuit 22 and a driver control circuit 23. The setting section 21 is configured such that a timing pulse for inserting a black signal is generated by a driver control circuit 23 on the basis of a condition set by the black signal insertion timing setting section 21.

With respect to the black insertion rate, an inverse transfer phenomenon occurs if a white display is continued at a low voltage as described above. Thus, the black signal of a high voltage is inserted by 15% to 20% on a one-field by one-field basis, thereby making it possible to prevent an occurrence of the inverse transfer phenomenon. For this purpose, each gate line is turned ON twice so as to write the black signal in addition to the video signal in a 1-field period, so that the black insertion rate is determined depending on the timings. Black insertion for applying the high voltage is carried out by writing the black signal. In the video display period, writing of the video signal and writing of the black signal are alternately carried out during first and second period provided for each 1H period. In the blanking period, writing of the black signal is carried out during the video-signal omission period (the first period) as well as the black signal period (the second period), thereby attempting to eliminate insufficient charging of the source lines.

The controller 13 supplies drive signals to a gate driver 15 and a source driver 16, respectively. A gate pulse, a video signal, a black signal, and other signals are supplied from the gate driver 15 and the source driver 16 to a flat display panel 17 such as an OCB-type liquid crystal display panel. Drive voltages are also supplied to the gate driver 15 and the source driver 16 from a drive voltage generator circuit 18 which is connected to the input power supply 12. The gate driver 15 and the source driver 16 are configured to display an image on the flat display panel 17 using the drives voltage and gate pulse as well as the video signal, etc.

In a video display period process of the black signal insertion timing setting section 21, the black signal is written and inserted into one field at a proper timing so as to reliably prevent an occurrence of an inverse transfer phenomenon. In a blanking period process of the black signal insertion timing setting section 21, an initiation timing of writing the black signal is shifted into the video-signal omission period in 1H. In setting of a black signal insertion timing for the blanking period, the insertion position and level of the black signal is determined based on a temperature or a display image.

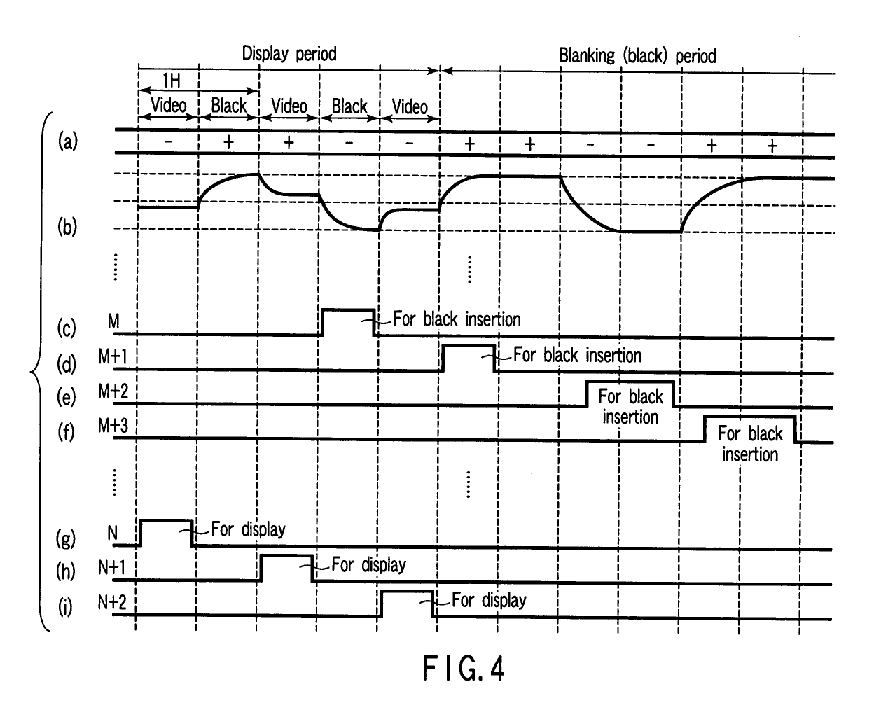

That is, as shown in FIG. 4, a video signal and a black signal are alternately written during a 1H period of the video display period, and the blanking period serves as a black display period. As shown in (a) of FIG. 4, the video signal and the black signal are supplied to the source driver 16 as signals whose polarities are inverted every 1H. The source line charge waveform is determined by each of the signals supplied to the source driver 16 such that the source line is charged or discharged according to the signal polarity, as shown in (b) of FIG. 4. At this time, the gate driver 15 operates to supply a gate signal. A black insertion gate pulse is supplied, for example, to an M-th gate line at a time slot for the black signal in the video display period, as shown in (c) of FIG. 4. Similarly, to an M+1-th gate line, a black insertion gate pulse is supplied at a time slot for the black signal in the blanking period, as shown in (d) of FIG. 4. To an M+2-th gate line, a black insertion gate pulse is supplied at a time slot for video-signal omission and an original time slot for the black signal in the blanking period, as shown in (e) of FIG. 4. Similarly, to an M+3-th gate line, a black insertion gate pulse is supplied at a time slot for video-signal omission and an original time slot for the black signal in the blanking period, as shown in (f) of FIG. 4. Thus, a write period for black signal insertion is extended to prevent insufficient charging of the source lines caused when a black signal insertion gate pulse for gating through a gate line is generated only at the original insertion time slot for the black signal.

As described above, the illustrative embodiment employs a pair of pulses for writing the video signal and the black signal in this order in 1H period, it is possible to employ a pair of pulses for writing the video signal and the black signal in an opposite order in 1H period. Namely, the write period for black signal insertion in the blanking period is substantially extended as compared with that in the video display period, whereby insufficient charging may be eliminated. Accordingly, instead of the black signal insertion gate pulse shown in, for example, (e) or (f) of FIG. 4, an independent black signal insertion gate pulse may be supplied during each of the video-signal omission period and the black signal period in the blanking period. In this case, the write period for the black signal is extended as compared with the write period for the black signal in the video display period, whereby a similar advantageous effect can be attained. This extension range can be freely set by the controller 13, and can be properly selected according to a temperature or the nature of a display image.

On the other hand, a video signal writing gate pulse is supplied to an N-th gate line, as shown in (g) of FIG. 4. Video signal writing gate pulses are supplied to an N+1-th gate line and an N+2-th gate line in the video display period, as shown in (h) of FIG. 4 and (i) of FIG. 4, respectively.

In this manner, the video-signal omission part of the blanking period is effectively used to obtain an optimum write timing for black insertion. Thus, it is possible to eliminate insufficient charging and attain the black insertion rate required for effectively and reliably preventing an inverse transfer phenomenon.

This black insertion is carried out for each vertical scan period (V), and a black signal write timing for black insertion can be freely set by changing the black insertion rate.

Such a flat display device is used as a display for displaying an image. The operating conditions of the display device vary with the external environment. Thus, it is desirable that the black insertion rate be changed in order to ensure an optimal operating condition in the environment as well. In this case, the black insertion rate is changeable by an external adjustment.

To change the black insertion rate, a register converter circuit (not shown) may be provided in the controller 13 to control the black insertion timing determining circuit 22 such that the black signal insertion timing is conditionally changed. For example, in the case where a temperature is high, the black signal insertion rate is increased in a digital process of the black insertion timing determining circuit 22 under the control of the register converter circuit, so that the black display voltage can be decreased to suppress the lowering of a contrast on the flat display panel 17. With the structure, when a temperature sensor or the like has detected a temperature change of the flat display panel 17 due to a change of the ambient environment temperature, it is possible to set a black signal insertion timing optimized for its use condition by changing the black insertion rate in unison with the temperature change.

While the above embodiment has described a case in which an OCB-type liquid crystal display panel is used as the flat display panel 17, an electroluminescent display panel can also be used. Further, in the case where the brightness of back light is changed according to the contents of a moving image displayed on the flat display panel 17 as well, it is possible to provide a configuration so as to change the brightness together with the black insertion rate. Of course, various applications or modifications can occur within the range without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flat display panel driving method for driving a flat display panel which includes a matrix array of pixels, a plurality of scanning lines for selecting rows of pixels, and a plurality of signal lines for supplying signals to a selected row of pixels, the method comprising:
writing a video signal and a non-video signal into different rows of pixels during first and second periods provided for each horizontal scan period, respectively; and
precharging said signal lines during the first period to assist writing of the non-video signal assigned to the second period, as a blanking period process after writing of the video signal has been completed with respect to all the rows of pixels.

2. The driving method according to claim 1, wherein an initiation timing of writing the non-video signal is shifted into said first period to precharge said signal lines.

3. The driving method according to claim 1, wherein an intermediate gradation signal is written in said first period to precharge said signal lines.

4. The driving method according to claim 1, said flat display panel is an OCB-type liquid crystal display panel.

5. A flat display device comprising:
a flat display panel which includes a matrix array of pixels, a plurality of scanning lines for selecting rows of pixels, and a plurality of signal lines for supplying signals to a selected row of pixels;
a driver circuit which writes a video signal and a non-video signal into different rows of pixels during first and second periods provided for each horizontal scan period, respectively; and
a controller which performs control of the driver circuit for precharging the signal lines during the first period to assist writing of the non-video signal assigned to the second period, as a blanking period process after writing of the video signal has been completed with respect to all the rows of pixels.

6. The flat display device according to claim 5, wherein said controller includes a timing setting section which sets an initiation timing of writing the non-video signal, said initiation timing being shifted into said first period to precharge said signal lines.

7. The flat display device according to claim 5, wherein said controller includes a gradation setting section which sets an intermediate gradation signal that is written in said first period to precharge said signal lines.

8. The flat display device according to claim 5, said flat display panel is an OCB-type liquid crystal display panel.
